(19) United States
(12) Patent Application Publication
(10) Pub. No.: US 2026/0010922 A1
(43) Pub. Date: Jan. 8, 2026

(54) METHODS AND SYSTEMS FOR PERFORMING SITE SELECTION FOR A RETAIL ESTABLISHMENT

(71) Applicant: SPIRO MOBILITY HOLDCO DMCC, DUBAI (AE)

(72) Inventors: Yogesh Suresh DIPANKAR, Pune (IN); Ajinkya PATIL, Pune (IN); Wasim TAMBOLI, Pune (IN); Nihal MESHRAM, Pune (IN)

(21) Appl. No.: 19/260,676

(22) Filed: Jul. 7, 2025

(30) Foreign Application Priority Data
Jul. 4, 2024 (IN) 202441051436

(51) Int. Cl. G06Q 30/0202

(52) U.S. Cl. CPC G06Q 30/02023

(57) ABSTRACT

Embodiments disclosed herein relate to managing one or more retail establishments, and more particularly to selecting a suitable site for a retail establishment. Embodiments herein disclose a suitable site for a retail establishment using an Analytical Hierarchy Process (AHP), wherein AHP uses multiple data sources (such as, but not limited to, population data, road network, petrol stations, shopping malls, parking, transport, building, land use, Point of Interests (POIs), vehicle telematics, and so on) and prioritizing key needs for locating a site near a specific area by weighing factors (such as, but not limited to, environmental criteria, site attributes, road access, population density, and so on).

### CROSS REFERENCE TO RELATED APPLICATION

This application is based on and derives the benefit of Indian Provisional Application IN202441051436, the contents of which are incorporated herein by reference.

### TECHNICAL FIELD

Embodiments disclosed herein relate to managing one or more retail establishments, and more particularly to selecting a suitable site for a retail establishment.

### BACKGROUND

Expansion planning and retail site selection have been a critical business decision for industries globally. Absence of a global standard for quantifying geographies with respect to demographic and socio-economic data parameters has been a need of the hour. There has been a great dependency on local knowledge pertaining to retail site selection decisions. However, with the advent of digital technology such as social media, mobile phones, maps, ecommerce, logistics, last mile delivery, and so on, there is a digital trace of data that allows quantification of demographics and socio-economic data parameters at a minute geographic level/micro-markets.

Current solutions are limited based on consultation with locals and some market study of the area, which is limited to accessibility and footfall related information.

However, there is a bias when it comes to local knowledge and there may be a gap between product to market fit understanding. Further, some factors may not be considered while assessing market and site conditions.

Hence, there is a need in the art for solutions which will overcome the above mentioned drawback(s), among others.

### Objects

The principal object of embodiments herein is to disclose methods and systems for selecting a suitable site for a retail establishment using an Analytical Hierarchy Process (AHP), wherein AHP uses multiple data sources (such as, but not limited to, population data, road network, petrol stations, shopping malls, parking, transport, building, land use, Points of Interest (POIs), vehicle telematics, settlement spread (night lights), building information (such as, but not limited to, Google Building Dataset, Open Building, and so on), Synthetic Aperture Radar (SAR) (Slope), electricity transmission network, and so on) and prioritizing key needs for locating a site near a specific area by weighing factors (such as, but not limited to, environmental criteria, site attributes, road access, population density, and so on).

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

Embodiments herein are illustrated in the accompanying drawings, throughout which like reference letters indicate corresponding parts in the various figures. The embodiments herein will be better understood from the following description with reference to the following illustratory drawings. Embodiments herein are illustrated by way of examples in the accompanying drawings, and in which:

FIG. 1 depicts a system for selecting a site for setting up a retail establishment, according to embodiments as disclosed herein;

FIG. 2 illustrates an example scenario, wherein 100×100 meter grids are overlaid on a target area, according to embodiments as disclosed herein;

FIG. 3 illustrates an example scenario, wherein fuel stations are overlaid on a target area, according to embodiments as disclosed herein;

FIG. 4 illustrates an example scenario, wherein population data and fuel stations data are overlapped on a grid of the target area, according to embodiments as disclosed herein;

FIGS. 5A, and 5B depict an example scenario, wherein the raster is converted into the vector, according to embodiments as disclosed herein;

FIGS. 6A-6F illustrates example overlaps of one or more datasets on a grid of the target area, wherein, according to embodiments as disclosed herein;

FIGS. 7A and 7B are example flowcharts depicting the process of selecting a suitable site for a battery swapping station (i.e., an example of a retail establishment), according to embodiments as disclosed herein; and

FIGS. 8A, 8B, 8C and 8D depict an example scenario, wherein the locations for battery swapping stations (i.e., an example of a retail establishment) are determined, according to embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

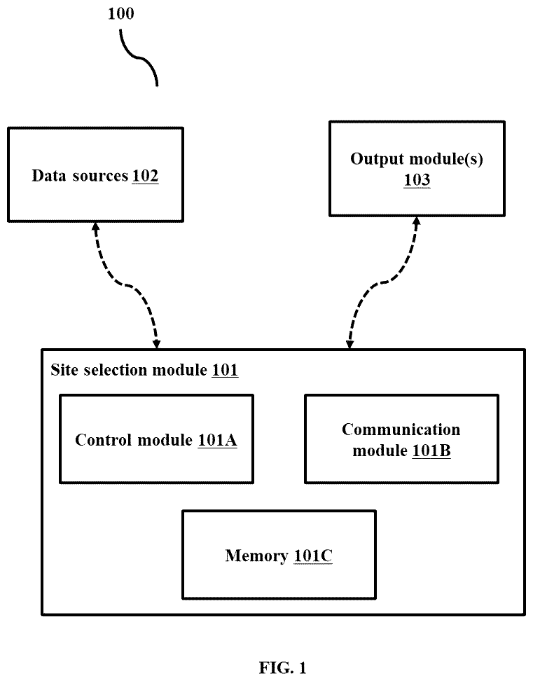

The embodiments herein achieve methods and systems for selecting a suitable site for a retail establishment using an Analytical Hierarchy Process (AHP). Referring now to the drawings, and more particularly to FIGS. 1 through 8D, where similar reference characters denote corresponding features consistently throughout the figures, there are shown embodiments.

FIG. 1 depicts a system for selecting a site for setting up a retail establishment. Examples of the retail establishment can be, but not limited to, a fuel station, a battery swapping station, a retail store, a shopping mall, showrooms, and so on.

The system 100, as depicted, comprises a site selection module 101, a plurality of data sources 102, and one or more output modules 103. The plurality of data sources 102 can be, but not limited to, datasets (such as population datasets), map sources (such as, but not limited to, Open Street Maps, Google Maps, Apple Maps, and so on), vehicle information (such as, but not limited to, vehicle telematics, and so on), and so on. The one or more output modules 103 can be at least one of a location where data/inferences/analysis can be stored/displayed, such as, but not limited to, a user device (such as, but not limited to, a phone, a smart phone, a computer, a laptop, a tablet, a wearable device, an Internet of Things (IoT) device, and so on), a data storage means (such as, but not limited to, a file server, a data server, the Cloud, and so on), and so on.

The site selection module 101 can further comprise a control module 101A, at least one communication module 101B, and a memory 101C. In the embodiment shown herein, the control module 101A may comprise one or more microprocessors, circuits, and other hardware configured for processing. The control module 101A can be configured to execute instructions stored in the memory 101C.

The control module 101A can be at least one of a single control module 101A, a plurality of processors, multiple homogeneous or heterogeneous cores, multiple Central Processing Units (CPUs) of different kinds, microcontrollers, special media, and other accelerators. The control module 101A may be an Application Processor (AP), a graphics-only processing unit such as a Graphics Processing Unit (GPU), a Visual Processing Unit (VPU), and/or an Artificial Intelligence (AI)-dedicated processor such as a Neural Processing Unit (NPU).

In the embodiment shown herein, the communication module 101B is configured to enable communication between the site selection module 101, and at least one external entity (such as, but not limited to, the plurality of data sources 102, and the one or more output modules 103) through a network or cloud. The server may be configured or programmed to execute the instructions of the site selection module 101. The communication module 101B through which the site selection module 101, and the server communicate may be in the form of either a wired network, a wireless network, or a combination thereof. The wired and wireless communication networks may comprise, but are not limited to, Global Positioning System (GPS), Global System for Mobile Communications (GSM), Local Area Network (LAN), Wireless Fidelity (Wi-Fi) compatibility, Bluetooth Low Energy (BLE), Near-field Communication (NFC), and so on. The wireless communication may further comprise one or more of Bluetooth, Zonal Intercommunication Global Standard (ZigBee), short-range wireless communication such as Ultra-wideband (UWB), medium-range wireless communication such as Wi-Fi, or long-range wireless communication such as Third Generation (3G), Fourth Generation (4G), or Worldwide Interoperability for Microwave Access (WiMAX), according to the usage environment.

In the embodiment shown herein, the memory 101C may comprise one or more volatile and non-volatile memory components that are capable of storing data and instructions to be executed. Examples of the memory 101C can be, but are not limited to, NAND, embedded Multimedia Card (eMMC), Secure Digital (SD) cards, Universal Serial Bus (USB), Serial Advanced Technology Attachment (SATA), Solid-State Drive (SSD), and so on. The memory 101C may also include one or more computer-readable storage media. Examples of non-volatile storage elements may include magnetic hard disks, optical discs, floppy discs, flash memories, or forms of Electrically Programmable Memories (EPROM) or Electrically Erasable and Programmable Memories (EEPROM). In addition, the memory 101C may, in some examples, be considered a non-transitory storage medium. The term “non-transitory” may indicate that the storage medium is not embodied in a carrier wave or a propagated signal. However, the term “non-transitory” should not be interpreted to mean that the memory 101C is non-movable. In certain examples, a non-transitory storage medium may store data that can, over time, change (e.g., in Random Access Memory (RAM) or cache). The memory 101C can further function as a centralized database to manage real-time updates and communication between the plurality of data sources 102, and the one or more output modules 103.

The control module 101A can collect the data from the plurality of data sources 102 related to a target area (i.e., the area where the retail establishment is aimed to be established). The collected data can comprise, but not limited to, population data, road network, petrol stations, shopping malls, parking, transport, building, land use, Point of Interests (POIs), vehicle telematics, settlement spread (night lights), building information (such as, but not limited to, Google Building Dataset, Open Building, and so on), parking data, the current retail establishments, Synthetic Aperture Radar (SAR) (Slope), electricity transmission network, and so on. Table 1 depicts example data sources.

TABLE 1

| Data type | Resolution | Source | Date |
|---|---|---|---|
| Settlement spread (Night | 30 m | NASA Black Marble | 2023 |
| Lights Data) | | Dataset | |
| Google Building Dataset | 10 m | Google | 2023 |
| Synthetic Aperture Radar | 10 m | Umbra Open Data | 2023 |
| (SAR) (Slope) | | Program | |
| Benin Electricity | NA | World Bank Group | 2023 |
| Transmission Network | | | |

Table 2 depicts example data.

TABLE 2

| Data type | Resolution | Source | Date | Remarks |
|---|---|---|---|---|
| population | 400 m | Kontur | 2023 | published by Kontur for year 2023 |
| data | | Population | | |
| | | Dataset | | |
| road | 10 m | Open Street | 2025 | national highways, state highways, |
| network | | Maps | | rural roads |
| petrol | 10 m | Open Street | 2025 | node[amenity = fuel] |
| stations | | Maps | | |
| shopping | 10 m | Open Street | 2025 | node[shop = mall] |
| malls | | Maps | | |
| parking | 10 m | Open Street | 2025 | node[“amenity”~“parking\|parking_{—} |
| | | Maps | | space”] |
| transport | 10 m | Open Street | 2025 | Bus, Railways, Airport |
| | | Maps | | |
| building | 10 m | Open Street | 2025 | Building Footprints |
| | | Maps (FB, | | |
| | | MS) | | |
| land use | 10 m | Open Street | 2025 | Residential, Commercial, |
| | | Maps | | Agricultural |
| | | (USGS) | | |
| POI | 10 m | Open Street | 2025 | shopping mall, hospitals, IT Parks |
| | | Maps | | |
| Vehicle - | | | 2024 | |
| Telematics | | | | |

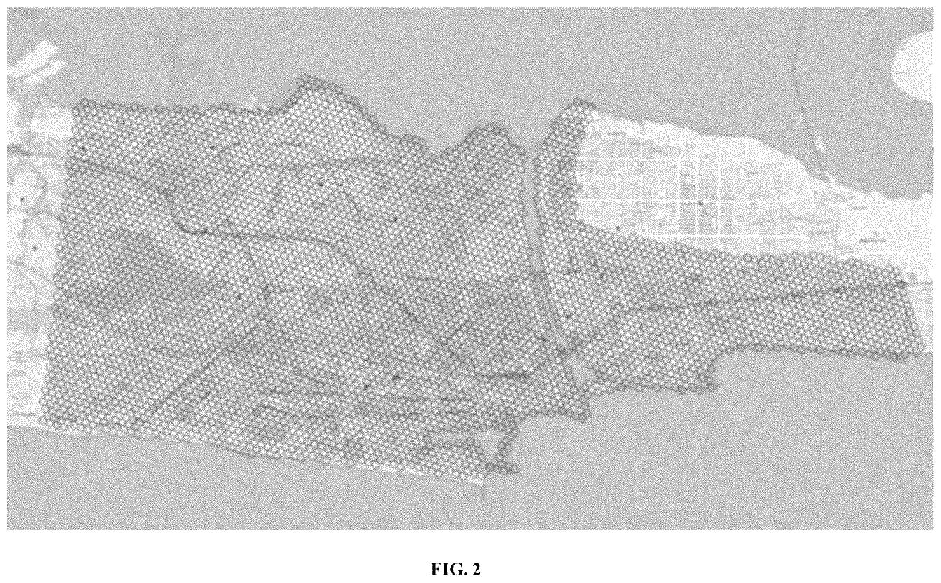

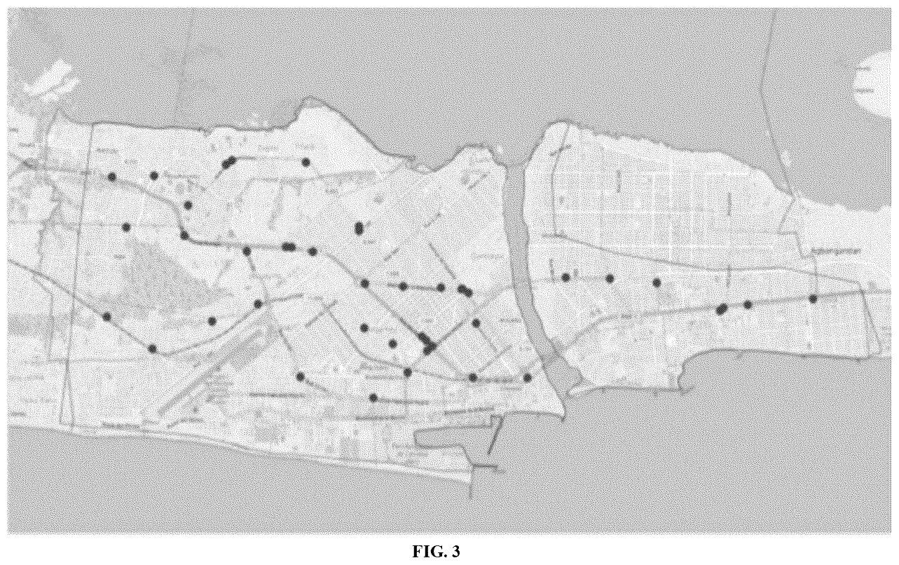

The control module 101A can prepare and process the collected data. Data preparation can involve dividing the target area into a plurality of grids of a pre-defined size (for example, 100×100 meter grids, as depicted in the example map depicted in FIG. 2). To facilitate distance calculations using the Euclidean function, the control module 101A can identify a grid number and latitude and longitude pairs at the centroid of each grid. For data analysis preparation, the control module 101A can consider a plurality of factors, such as, but not limited to, density, population, road type, natural information, fuel station and parking information, and community areas. The control module 101A can use a suitable means (such 10 as, but not limited to, Geographic Information System (GIS), and so on) to extract information from the map source. As an example, the control module 101A can query amenity areas categorized as “fuel,” as depicted in FIG. 3, wherein these areas, known as “fuel,” are typically situated near road networks. The control module 101A can consider the distribution of populated regions within the target area.

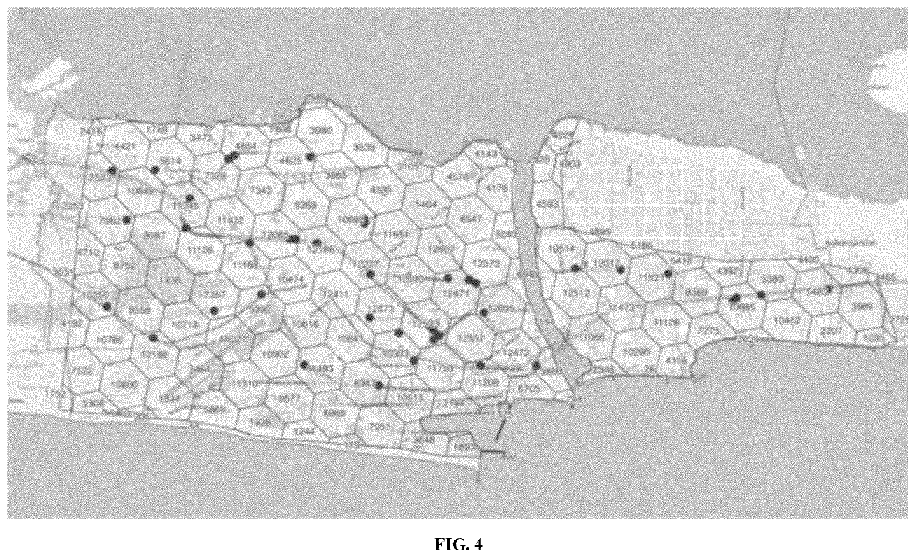

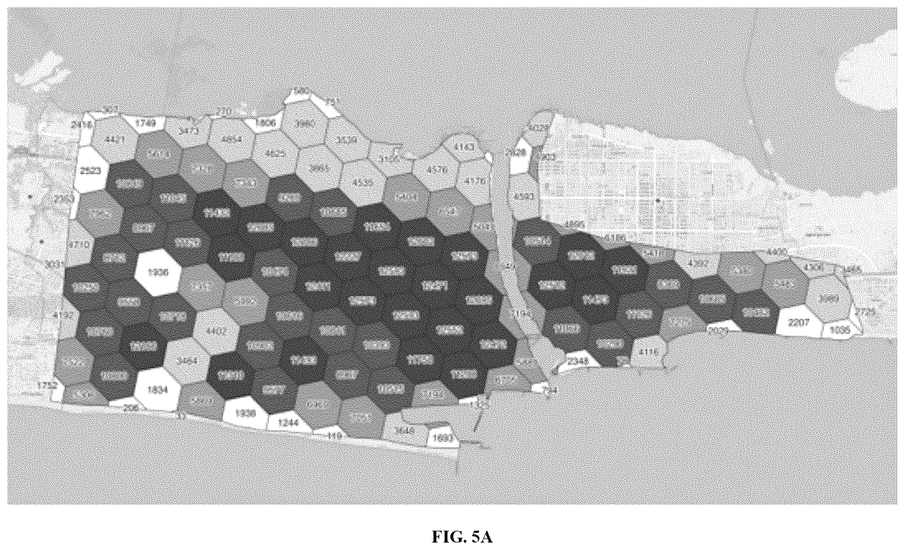

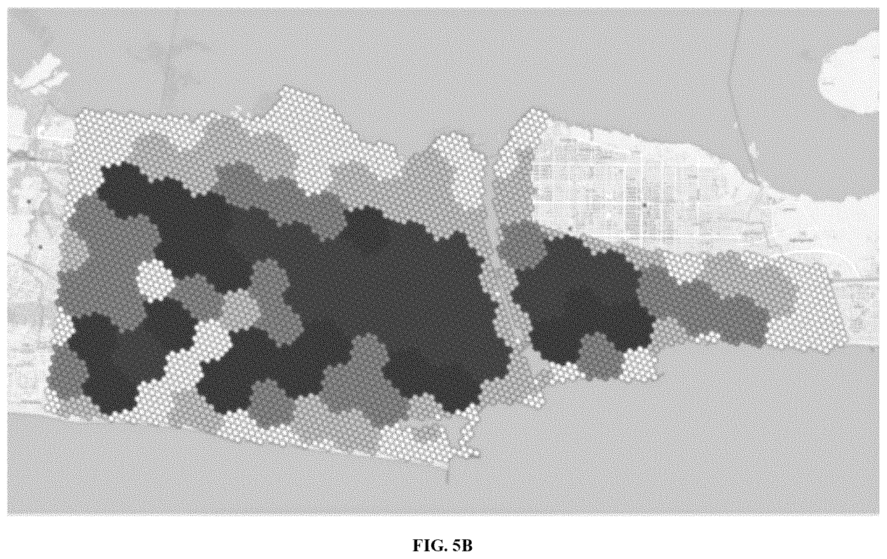

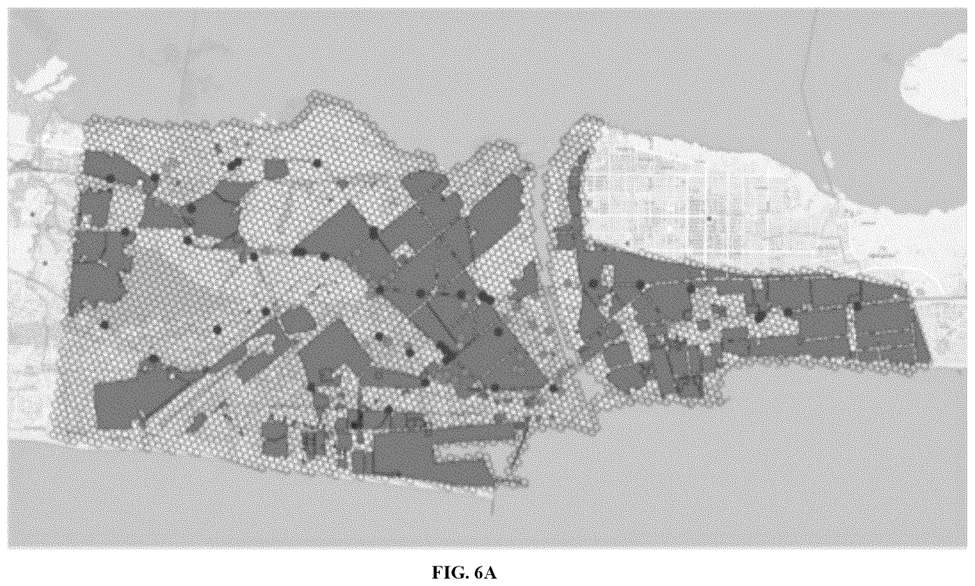

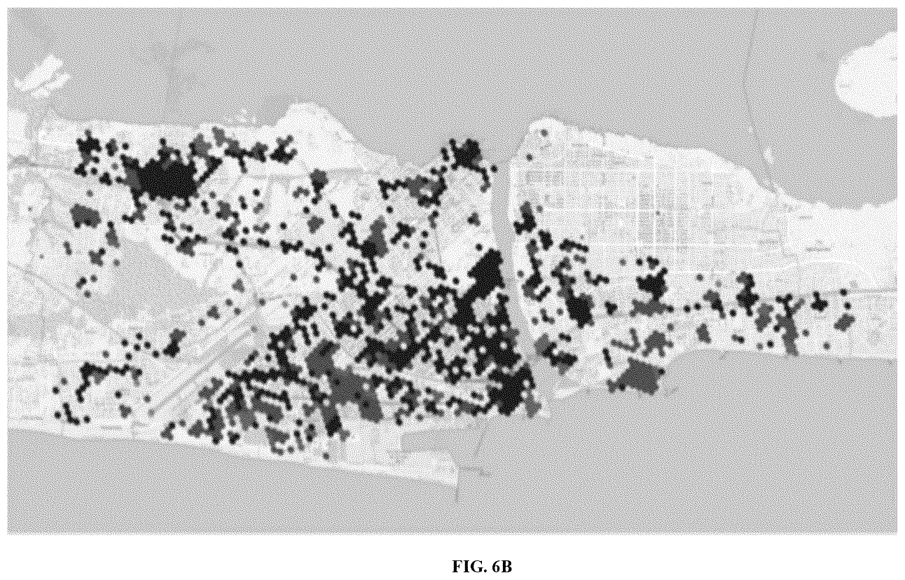

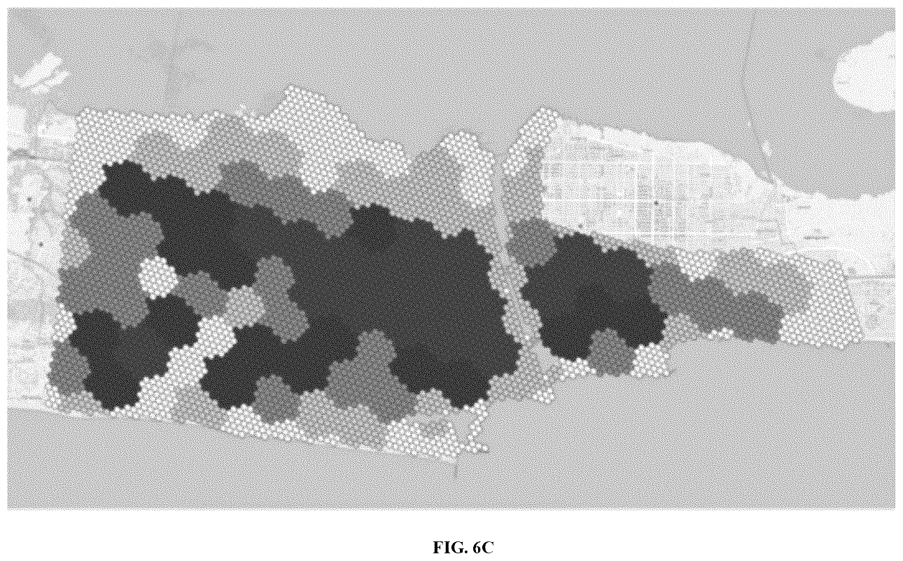

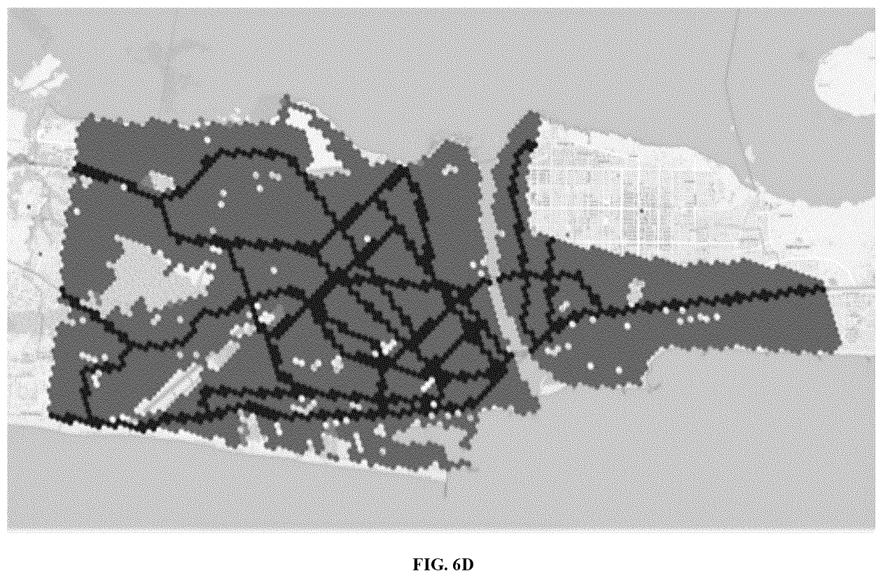

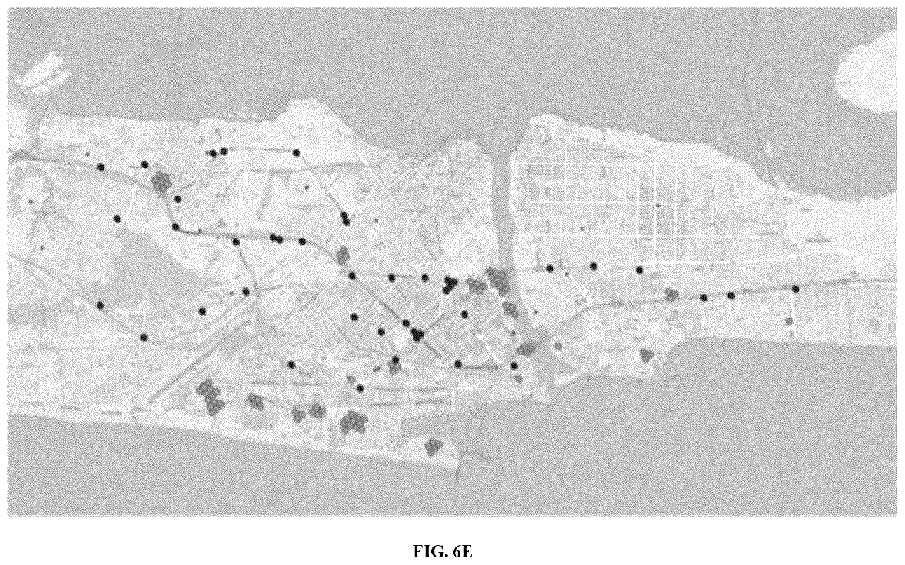

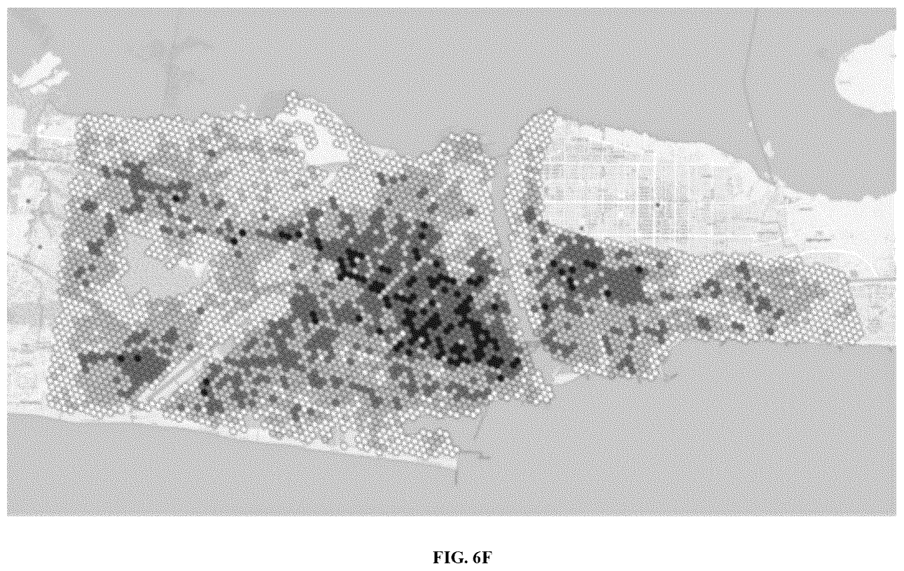

FIG. 4 depicts an example positioning of populated regions considering the population distribution and fuel stations (i.e., an overlap of population data and fuel station data), wherein numbers in the hexagon illustrate the population count. To normalize the population data, the control module 101A can convert the raster to a vector, wherein the control module 101A can use a Geographic Information System (GIS) for converting the raster to the vector. Once the conversion has been successfully completed, the control module 101A can join the population hex (as depicted in the example in FIG. 5A) and the grid by location and generate a combined file with smoothened values in the grid format (as depicted in the example in FIG. 5B). The control module 101A can plot a plurality of factors on a map, wherein the plurality of factors can be incorporated into the map, as depicted in the examples in FIGS. 6A-6F.

Once the data has been prepared, the control module 101A can integrate the prepared data onto the target area using overlays, wherein the integration comprises containing information (such as, but not limited to, grid number, coordinates, road type, amenity data, natural data, parking and fuel station data, and so on) on each grid in the target area. This involves the control module 101A using AHP, wherein one or more factors are compared with their respective hierarchy levels, using matrices with pre-defined values to signify their relative importance. The control module 101A can use AHP to tackle complex decisions with multiple criteria. It simplifies intricate problems by structuring them into smaller, hierarchical subproblems. The control module 101A can use AHP to prioritize one or more key needs for locating a site near a specific area by weighing factors, such as, but not limited to, environmental criteria, site attributes, road access, population density, and so on. Table 3 depicts an example list of factors (i.e., layer), when the retail establishment is a battery swapping station.

TABLE 3

| Layer | Value | Categories |
|---|---|---|
| Landuse | 5 | Urban Areas |
| | 4 | Recreational Areas |
| | 3 | Special Use Areas |
| | 2 | Agricultural Areas |
| | 1 | Natural Areas |
| Roads | 5 | Local Roads |
| | 4 | Main Roads |
| | 3 | Highways |
| | 2 | Special Use Roads |
| | 1 | Tracks and Grades |
| Buildings | 5 | Residential |
| | 4 | Commercial/Public |
| | 3 | Infrastructure |
| | 2 | Agricultural/Construction |
| | 1 | Uncategorized/Ruins |
| POI's | 5 | Commercial/Entertainment |
| | 4 | Public Facilities |
| | 3 | Outdoor/Recreation |
| | 2 | Historical/Cultural |
| | 1 | Utilities/Infrastructure |
| Transport | 5 | airport, bus_station, bus_stop, ferry_terminal, |
| | | railway_station, taxi |
| Population (Equal | 5 | population >= 11126 and population <= 12695 |
| count) | 4 | population >= 7522 and population < 11126 |
| Cotonou Specific | 3 | population >= 4535 and population |
| | 2 | population >= 1749 and population < 4535 |
| | 1 | population >= 0 and population < 1749 |
| parking-space | 5 | if (parking-space) |
| (osm_id) | | |
| shopping-mall | 5 | if (shopping-mall) |
| (osm_id) | | |
| fuel-stations | 5 | if (fuel-station) |
| (osm_id) | | |

Through the weighting and adjustment of the diverse factors, the control module 101A can pinpoint the most feasible and effective locations for site selection, ensuring maximum coverage and accessibility for users. To normalize all the criteria, the control module 101A can consider each layer's product with its defined weight, which can depend on the type of retail establishment.

The control module 101 can compare factors within each hierarchy level, using matrices with values between 1 and 5 to signify relative importance. In an example, table 4 highlights the significance of these values in the higher-level hierarchy, wherein table 4 depicts an example table, with the factor/layer and the respective weights, when the retail establishment is a battery swapping station. Through the weighting and adjustment of these diverse factors, the control module 101A can pinpoint the most feasible and effective locations for site selection, ensuring maximum coverage and accessibility for users. To normalize all the criteria, the control module 101A can consider each layer's product with its defined weight.

TABLE 4

| Layer | Weight |
|---|---|
| land use | 0.075 |
| building | 0.15 |
| roads | 0.125 |
| population | 0.125 |
| poi | 0.05 |
| transport | 0.075 |
| fuel-station | 0.15 |
| parking-space | 0.15 |
| shopping-mall | 0.1 |

The control module 101A can consider both quantitative and qualitative criteria, encompassing population density, environmental aspects, and accessibility. By integrating quantitative and qualitative criteria and soliciting input from key stakeholders, the control module 101A can provide a more robust and effective approach to location-based decision-making.

FIGS. 6A-6F depict example factors plotted on a map of the target area. The example depicted in FIG. 6A illustrates overlap of all available datasets; wherein blue points are fuel stations, green points are shopping malls, pink points are transport means, and orange polygons are land use. FIG. 6B illustrates POIs overlaid on the grid. FIG. 6C illustrates population distribution overlaid on the grid. FIG. 6D illustrates road data overlaid on the grid. FIG. 6E illustrates parking overlaid on the grid. FIG. 6F illustrates the grid with all available aggregated data, wherein the dark areas can be considered to be the most suitable sites for the retail establishment.

Based on the density of the data in the target area (i.e., the darkest area in the map), one or more optimal locations for sites can be selected in the target area.

Subsequently, the control module 101A can establish a pre-defined distance between the retail establishments (such as, but not limited to, 2.5 kilometers, 2 kilometers, 3 kilometers, and so on). Based on the pre-defined distance, the control module 101 can use Euclidean distance and nearest neighbor algorithm for the identifying suitable sites. Through the application of these methods, embodiments herein can successfully pinpoint one or more optimal locations for sites that guarantee maximum coverage and accessibility to users within the target area.

In an example herein, consider that the retail establishment is a retail shop. The control module 101A can identify areas with a high concentration of young families with disposable income for a toy store. The control module 101A can locate a high-end clothing store in areas with a high density of professionals with affluent lifestyles. The control module 101A can place a convenience store near residential areas with a high number of working adults who are short on time for grocery shopping.

In an example herein, consider that the retail establishment is a fuel station. The control module 101A can target high traffic areas with a significant number of commuters for a fuel station. The control module 101A can locate a fuel station near highways and major roads frequently used by long-distance travelers. The control module 101A can place a fuel station near truck stops or industrial areas with a high concentration of commercial vehicles.

In an example herein, consider that the retail establishment is a showroom. If the showroom is a luxury vehicle showroom, the control module 101A can locate a site of a car showroom near affluent neighborhoods where there is a high demand for luxury vehicles. If the showroom is a motorbike vehicle showroom, the control module 101A can locate a motorbike showroom near areas with a young population who are likely interested in two-wheeler transportation. If the showroom is a furniture showroom, the control module 101A can place the furniture showroom near newly constructed housing areas where residents are likely to be furnishing their homes.

Embodiments herein are explained using a battery swapping station as an example of a retail establishment. It may be obvious to a person of ordinary skill in the art that embodiments as disclosed herein may be extended to any type of retail establishment, wherein the data that is collected may vary based on the type of retail establishment.

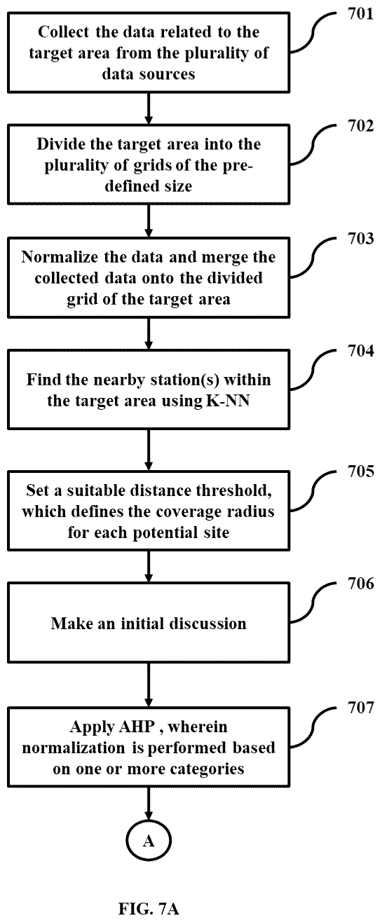

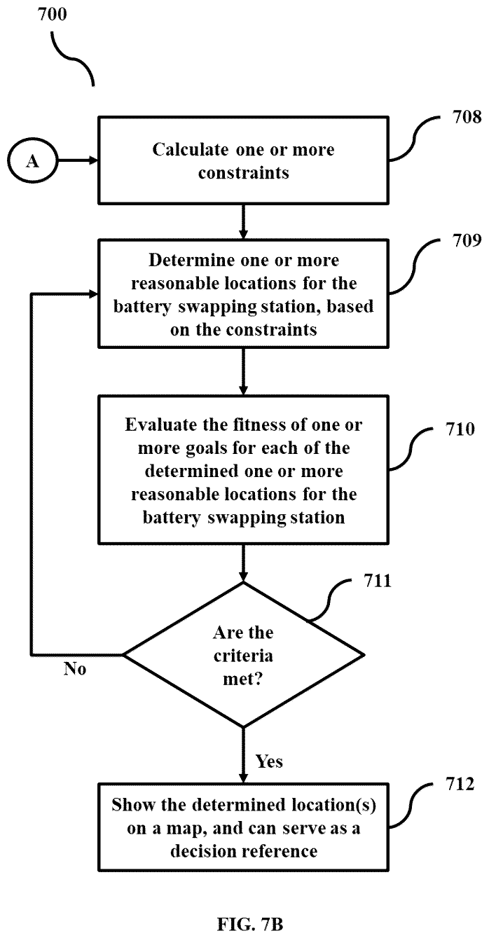

FIGS. 7A and 7B are example flowcharts depicting the process of selecting a suitable site for a battery swapping station (i.e., an example of a retail establishment). In step 701, the control module 101A collects the data related to the target area from the plurality of data sources 102. Examples of the collected data can include, but not limited to, population data, road network, land use, building, retail shopping centers, fuel stations, Places of Interest (POIs), transportation, parking data, and so on. In step 702, the control module 101A divides the target area into the plurality of grids of the pre-defined size (for example, 100×100 meter grids). In step 703, the control module 101A normalizes the data, merges the collected data onto the divided grid of the target area, and determines a score for each grid cell (based on the collected data). In an embodiment herein, the score can be high for cells where certain desired data points are met. For example, if a cell has a retail establishment, then the score for that cell will be low. Considering the example of a battery swapping station, a cell where an office commuter route is present, the score for the cell can be high. Considering the example of a shopping center, a cell where POIs, a good road network, zoned lands, good transportation, and good parking are present, the score for the cell can be high. Considering the example of a shopping center, a cell where there is no good road network, and is sparsely populated, the score for the cell can be low. In step 704, the control module 101A finds the nearby station(s) (i.e., a retail establishment offering similar services) within the target area using a K nearest neighbors (K-NN) algorithm. In step 705, the control module 101A can set a distance threshold, which defines the coverage radius for each potential site. In step 706, the control module 101A makes an initial decision; i.e., determines the areas not covered by existing swap stations. From these, an initial starting point in the map can be selected. In an embodiment herein, the initial starting point can be the grid cell with the highest score. The initial decision involves the control module 101A selecting a starting point based on scores generated from collected data, while excluding areas already covered by existing swap stations, if applicable. In step 707, the control module 101A applies Analytic Hierarchy Process (AHP) for each cell, based on one or more categories (such as, but not limited to, nearby fuel stations, shopping centers, parking, transportation, and so on), and the categories are defined by an authorized user. In step 708, the control module 101A calculates one or more constraints for each cell, such as:
The score exceeds a defined threshold (e.g., a score above 50% indicates the location meets at least 50% of the desired criteria).
The coverage from this cell location is evaluated using the distance (as defined in step 705), and a check is made as to whether the coverage from the cell overlaps with the coverage area of any existing site by generating isochrones from this cell location.

If the cell satisfies these constraints, the cell can be selected as a desired swap station location. Steps 707 and 708 are then repeated until either the required number of sites is selected, or the entire target area is adequately covered. Examples of the constraints can be maximum coverage percentage using isochrones, minimum number of stations (i.e., locations) required in the target area, and so on. In step 709, the control module 101A determines one or more reasonable locations for the battery swapping station (i.e., the retail establishment), based on the constraints. In step 710, the control module 101A evaluates the fitness of one or more criteria/goals for each of the determined one or more reasonable locations for the battery swapping station. Examples of the goals can be, but not limited to, maximum coverage percentage area, reasonableness of the determined location, and any other goal as defined by an authorized user. If the criteria are met (step 711), in step 712, the control module 101A displays the determined location(s) on a map, and can serve as a decision reference. The various actions in method 700 may be performed in the order presented, in a different order or simultaneously. Further, in some embodiments, some actions listed in FIGS. 7A and 7B may be omitted.

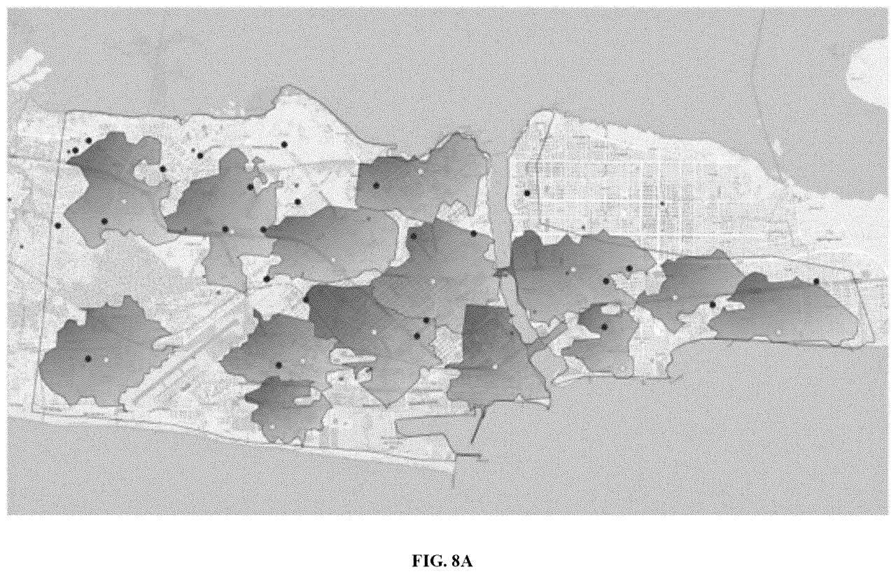

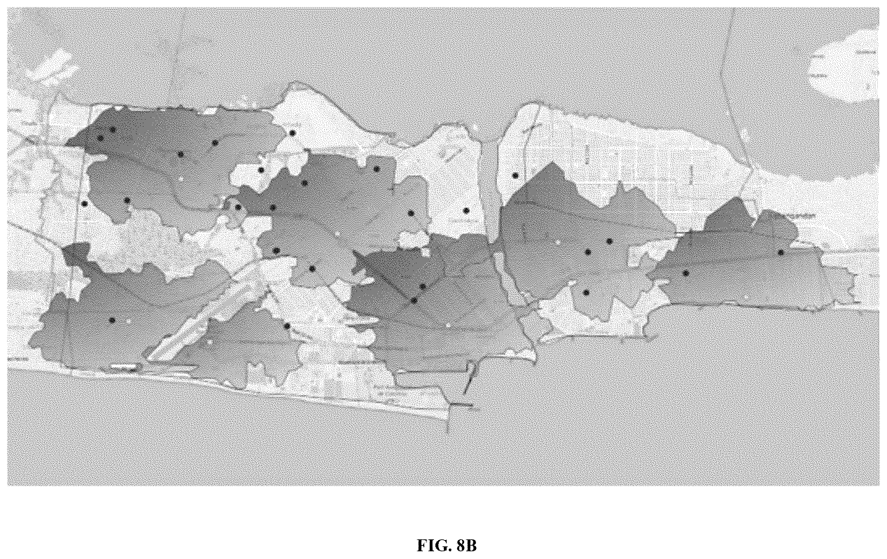

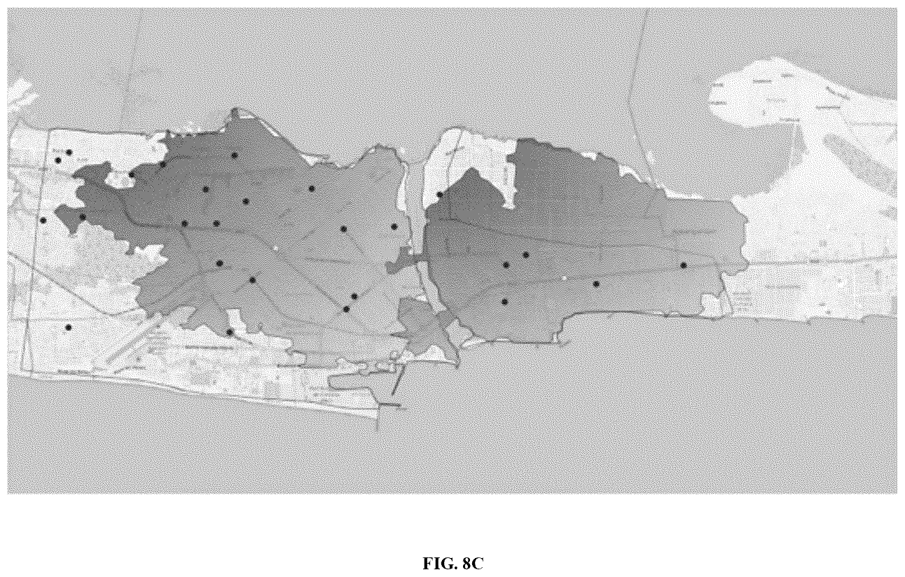

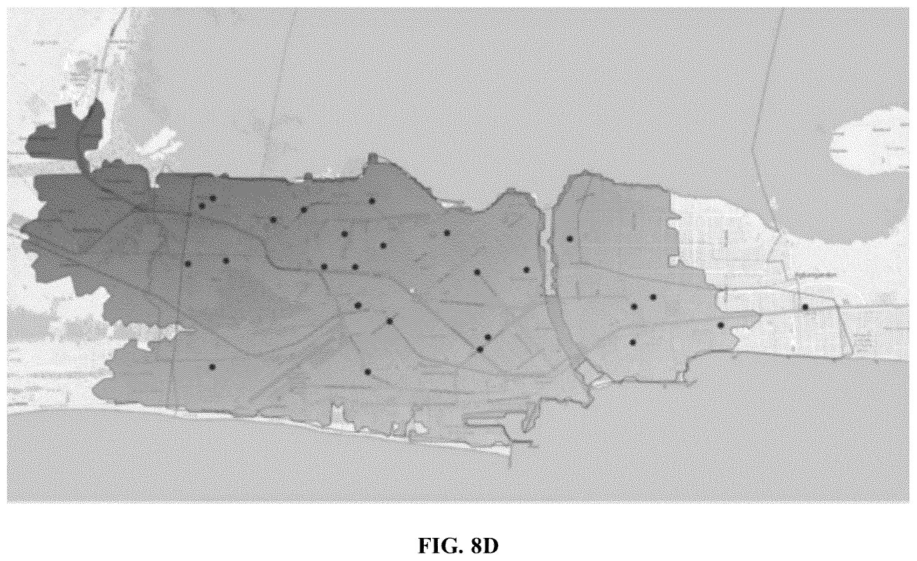

The approach as disclosed herein was used to optimise the swap station network in Cotonou, Benin to improve overall profitability of the stations. The station count can be reduced by 30% over a span of 3 months, with minimal impact on the swap counts and revenue generated from these regions. FIG. 8A illustrates the isochrones for 1500 meters wherein the suitable sites are yellow points (14), and existing sites are red points (27). FIG. 8B illustrates the isochrones for 2500 meters wherein the suitable sites are yellow points (7), and existing sites are red points (27). FIG. 8C illustrates the isochrones for 5000 meters wherein the suitable sites are yellow points (2), and existing sites are red points (27). FIG. 8D illustrates the isochrones for 10000 meters wherein the suitable sites are yellow points (1), and existing sites are red points (27).

The embodiments disclosed herein can be implemented through at least one software program running on at least one hardware device and performing network management functions to control the network elements. The elements include blocks which can be at least one of a hardware device, or a combination of hardware device and software module.

The embodiments disclosed herein describe methods and systems for selecting a suitable site for a retail establishment using an Analytical Hierarchy Process (AHP). Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the invention may be implemented on different hardware devices, e.g., using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practised with modification within the scope of the embodiments as described herein.

We claim:

1. A method (700) for selecting a site for a retail establishment in a target area, the method comprising:
collecting (701), by a site selection module (101), data related to the target area from at least one data source;
dividing (702), by the site selection module (101), the target area into a plurality of grids of a pre-defined size;
normalizing (703), by the site selection module (101), the collected data by merging the collected data onto the divided grid of the target area, and determining a score for each grid cell based on the collected data;
finding (704), by the site selection module (101), at least one nearby similar retail establishment within the target area using a K nearest neighbors (K-NN) algorithm;
setting (705), by the site selection module (101), a distance threshold;
making (706), by the site selection module (101), an initial decision;
applying (707), by the site selection module (101), an Analytic Hierarchy Process (AHP) for each cell in the grid;
determining (708), by the site selection module (101), one or more constraints for each cell in the grid;
determining (709), by the site selection module (101), one or more reasonable locations for the retail establishment, based on the constraints;
evaluating (710), by the site selection module (101), fitness of one or more criteria for each of the determined one or more reasonable locations for the retail establishment; and
displaying (712), by the site selection module (101), the determined location(s) on a map, if the criteria are met.

2. The method, as claimed in claim 1, wherein the collected data includes population data, population distribution, road network, petrol stations, shopping malls, parking, transport, building, land use, Point of Interests (POIs), vehicle telematics, settlement spread (night lights), building information, parking data, the current retail establishments, Synthetic Aperture Radar (SAR) (Slope), and electricity transmission network in the target area.

3. The method, as claimed in claim 1, wherein dividing the target area into the plurality of grids of the pre-defined size comprises using a Euclidean function.

4. The method, as claimed in claim 1, wherein making the initial decision comprises:
selecting, by the site selection module (101), an initial starting point, wherein the starting point is a cell in the grid with the highest score; and
excluding, by the site selection module (101), cells in the grid where the retail establishment is already present.

5. The method, as claimed in claim 1, wherein the method comprises integrating, by the site selection module (101), prepared data onto the target area using overlays by applying the AHP.

6. The method, as claimed in claim 5, wherein applying the AHP comprises performing, by the site selection module (101), normalization on the collected data based on at least one category, wherein the category is defined by an authorized user, and further comprises:
comparing, by the site selection module (101), at least one factor with respective hierarchy levels, wherein matrices with pre-defined values are used to signify their relative importance.

7. The method, as claimed in claim 1, wherein the constraints comprise maximum coverage percentage using isochrones, and minimum number of retail establishments required in the target area.

8. The method, as claimed in claim 1, wherein the one or more criteria comprise maximum coverage percentage area, reasonableness of the one or more reasonable location, and any other goal as defined by an authorized user.

9. The method, as claimed in claim 1, wherein a product of each layer of the map is considered with its defined weight, which can depend on type of the retail establishment.

10. A site selection module (101) comprising:
a control module (101A);
at least one communication module (101B); and
a memory (101C),
wherein the control module (101A) is coupled with the at least one communication module (110B), and the memory (101C), wherein the control module (101A) is configured to:
collect data related to the target area from at least one data source;
divide the target area into a plurality of grids of a pre-defined size;
normalize the collected data by merging the collected data onto the divided grid of the target area, and determining a score for each grid cell based on the collected data;
find at least one nearby similar retail establishment within the target area using a K nearest neighbors (K-NN) algorithm;
set a distance threshold;
make an initial decision;
apply an Analytic Hierarchy Process (AHP) for each cell in the grid;
determine one or more constraints for each cell in the grid;
determine one or more reasonable locations for the retail establishment, based on the constraints;
evaluate fitness of one or more criteria for each of the determined one or more reasonable locations for the retail establishment; and
display the determined location(s) on a map, if the criteria are met.

11. The site selection module, as claimed in claim 10, wherein the collected data includes population data, population distribution, road network, petrol stations, shopping malls, parking, transport, building, land use, Point of Interests (POIs), vehicle telematics, settlement spread (night lights), building information, parking data, the current retail establishments, Synthetic Aperture Radar (SAR) (Slope), and electricity transmission network in the target area.

12. The site selection module, as claimed in claim 10, wherein the control module (101A) is configured to divide the target area into the plurality of grids of the pre-defined size using a Euclidean function.

13. The site selection module, as claimed in claim 10, wherein the control module (101A) is configured to:
select an initial starting point, wherein the starting point is a cell in the grid with the highest score; and
exclude cells in the grid where the retail establishment is already present.

14. The site selection module, as claimed in claim 10, wherein the control module (101A) is configured to integrate prepared data onto the target area using overlays by applying the AHP.

15. The site selection module, as claimed in claim 14, wherein the control module (101A) is configured to apply the AHP by performing normalization on the collected data based on at least one category, wherein the category is defined by an authorized user, wherein the control module (101A) is configured to:
compare at least one factor with respective hierarchy levels, wherein matrices with pre-defined values are used to signify their relative importance.

16. The site selection module, as claimed in claim 10, wherein the constraints comprise maximum coverage percentage using isochrones, and minimum number of retail establishments required in the target area.

17. The site selection module, as claimed in claim 10, wherein the one or more criteria comprise maximum coverage percentage area, reasonableness of the one or more reasonable location, and any other goal as defined by an authorized user.

18. The site selection module, as claimed in claim 10, wherein a product of each layer of the map is considered with its defined weight, which can depend on type of the retail establishment.
